(19) United States
(12) Patent Application Publication
(10) Pub. No.: US 2024/0235636 A1
(43) Pub. Date: Jul. 11, 2024

(54) METHODS AND SYSTEMS TO PRODUCE FULLY-CONNECTED OPTICAL BEAMFORMING

(71) Applicants: HUAWEI TECHNOLOGIES CANADA CO., LTD., Kanata (CA); The University of British Columbia, Vancouver (CA); Queen's University at Kingston, Kingston (CA)

(72) Inventors: Armaghan ESHAGHI, Kanata (CA); Mahsa SALMANI, Kanata (CA); Enxiao LUAN, Kanata (CA); Mitchell NICHOLS, Vancouver (CA); Lutz Hans-Joachim LAMPE, Vancouver (CA)

(73) Assignees: HUAWEI TECHNOLOGIES CANADA CO., LTD., Kanata, ON (CA); The University of British Columbia, Vancouver, BC (CA); Queen's University at Kingston, Kingston, ON (CA)

(21) Appl. No.: 18/612,448

(22) Filed: Mar. 21, 2024

Related U.S. Application Data
(63) Continuation of application No. PCT/CA2021/051489, filed on Oct. 22, 2021.

(51) Int. Cl. H04B 7/06; H04B 7/0452

(52) U.S. Cl. CPC H04B 7/0617; H04B 7/0452

(57) ABSTRACT

A method of beamforming by which a signal can be received into an array of channels, each of which is split into a real-part sub-channel and an imaginary part sub-channel. In each sub-channel, optical waves are used to carry the signal via waveguides. Each channel includes a real-part sub-channel where an optical wave is scaled by the real part of a complex number, and an imaginary part sub-channel, where a complementary optical wave is scaled by the complex part of the same complex number. When the complementary optical waves are received at the channel's output, they can be shifted by the phase of the complex number having defined their scaling. By processing a signal with a system operative to perform such method, the application of a different phase to each channel can result in a beamforming of the signal.

### CROSS-REFERENCE TO RELATED APPLICATIONS

The present application is a continuation of International Application No. PCT/CA2021/051489 filed Oct. 22, 2021 and entitled “METHODS AND SYSTEMS TO PRODUCE FULLY-CONNECTED OPTICAL BEAMFORMING”, the contents of which are incorporated herein in their entirety.

### TECHNICAL FIELD

This disclosure pertains generally to the field of optical beamforming, and in particular, to systems and methods to implement beamforming with a weight bank of optical modulators.

### BACKGROUND

It is expected that the next generations of wireless communication networks, i.e. 5G and 6G, will provide very high data rates (>1 Gbps), very low latency (<1 ms), ultra-high reliability, and low energy consumption. The use of millimeter-wave (mmWave) communication (>10 GHZ) can enable networks to meet these stringent requirements. Communication channels at mmWave frequencies can offer much higher bandwidths and data rates that are higher by orders of magnitude. Transceivers in such networks should be equipped with very fast and reasonably low power consuming signal processing architectures in the digital and/or analog domains. Moreover, because the wavelength of mmWave signals is shorter than that of prior systems, a massive number of antennas (i.e. an array of antennas) can be deployed in a relatively small area, giving rise to the concept of multiple-input multiple-output (MIMO) for mmWave communications. In MIMO systems, the propagation characteristics of mmWave channels, such as propagation losses and channel intermittency, can be mitigated or resolved by employing techniques known as beamforming.

Several beamforming approaches face different challenges in terms of power consumption, insertion loss, and in particular, scalability. Such challenges can preclude certain architectures from being used in some radio frequency (RF) beamforming architectures. For example, an optical beamforming network (OBFN) based on Mach-Zehnder modulators (MZM) can require a coherent, single wavelength light source, and cannot easily be extended to support multiple data streams. Therefore, these are not suitable for the next generations of wireless communications, where a massive number of users are to be supported by a massive number of antenna elements at the base station (BS). Moreover, to provide sufficient group delay for RF beamforming applications, true optical time delay lines can have relatively large footprints.

For mmWave beamforming, there are generally three basic architectures: analog beamforming, digital beamforming, and hybrid beamforming which combines both analog and digital beamforming. A drawback of analog beamforming is that it can be limited to supporting one data stream at a time. The architecture can have low power consumption, but when many antennas are involved, the high number of signal divisions can cause high insertion losses. Digital beamforming can support a higher number of data streams as compared to analog beamforming. However, the electronic components in each RF chain can have large power consumption, and the signal processing required in digital beamforming architectures has a higher complexity.

In a multi-user massive MIMO system, a hybrid beamforming architecture can be beneficial as it offers concurrent support of multiple data streams at a lower cost, and a lower complexity, over digital beamformers. Although hybrid beamforming can provide advantages over each of the analog and digital beamforming architectures, in electronic implementations, the analog portion of a hybrid beamformer can suffer from insertion losses and transmission line losses that typically increase with the number of antennas. This can be due to the number of divisions in the signal path and the length of the transmission lines. To maintain signal powers at a useable level, it may be required for amplifiers to be embedded in the beamforming network (BFN).

Therefore, there is a need for methods and/or systems that can obviate or mitigate one or more limitations of the prior art, such as insufficient capacity of users, insufficient tunability, insufficient bandwidth, higher power consumption, higher insertion losses, higher latency, insufficient data rates, insufficient reliability, electromagnetic interference, larger footprints, and insufficient scalability.

This background information is provided to reveal information believed by the applicant to be of possible relevance to the present disclosure. No admission is necessarily intended, nor should be construed, that any of the preceding information constitutes prior art against the present disclosure.

### SUMMARY

Embodiments of the present disclosure include a beamforming architecture in which phase shifting at each antenna is performed by splitting the received signal into an in-phase component and a quadrature component and modulating each component separately with weights corresponding to the real and imaginary part of complex numbers for which the combination thereof results in the required phase.

In an embodiment, a signal can be converted into an optical signal made from a plurality of monochromatic optical waves passing through waveguide channels. A scaling factor (for example weight) can be applied to each monochromatic wave of an optical signal with a modulator operative to do so, based on a tunable parameter of the modulator such as a voltage or current. Such modulators can include modulated microring resonators (MRR), Mach-Zehnder interferometers (MZM), and other electronic devices and circuits. Modulation can be performed via physical effects such as a thermo-optic effect, a free-carrier plasma dispersion effect and others.

The combining of the monochromatic waves into phase-shifted signals can be performed with balanced photodiodes and/or down converters.

Benefits of embodiments can include improved scalability as optical architectures according to embodiments of the present disclosure can allow the processing of a greater number of beam components in a shorter amount of time, and therefore allow beamforming with higher data rates, lower latency, a smaller footprint and lower power consumption.

Architectures according to embodiments allow beamforming processing to be performed in the optical domain. By converting a signal to the optical domain, beam steering can be performed by phase-shifting individual monochromatic waves forming the optical signal, with a weight bank of optical modulators, the footprint of which can be small, and the speed of which can be large. Weight bank architectures and phase-shifting methods according to embodiments can be used as a basis for signal receivers as well as signal emitters that can quickly receive and emit a directed beam containing a large amount of data.

The use of sources of optical monochromatic wave allows conversion of electrical and RF signals into optical signals that can be phase-shifted at high-speed by a weight bank according to embodiments, and the use of balanced photodiodes allows for the conversion of optical signals into the electrical and RF domains. The use of up-converters and down-converters can allow for interfacing with the electrical domain.

In accordance with embodiments, there is provided a system for beamforming a signal, the system comprising one or more channels. Each channel includes a first sub-channel configured as a real-part sub-channel, the first sub-channel including a first waveguide and first optical modulators, each first optical modulator operative to modulate an amplitude of a monochromatic wave carrying the signal with a real part of a complex number, the complex number representing an associated phase. Each channel further includes a second sub-channel configured as an imaginary-part sub-channel, the second sub-channel including a second waveguide and second optical modulators, each second optical modulator operative to modulate the amplitude of the monochromatic wave carrying the signal with an imaginary part of the complex number. Combining the modulated monochromatic wave associated with the first sub-channel and the modulated monochromatic wave associated with the second sub-channel, results in the signal being shifted with the phase of the complex number.

In some embodiments, the two or more channels and respective first sub-channel and second sub-channel are in parallel.

In some embodiments, each first sub-channel includes a balanced photodiode operative to incoherently detect monochromatic waves upon modulation in the respective first sub-channel and wherein each second sub-channel includes a balanced photodiode operative to incoherently detect monochromatic waves upon modulation in the respective second sub-channel.

In some embodiments, the system further includes a wavelength division multiplexer (WDM) configured to transmit multiplexed monochromatic waves to each of the first sub-channels and each of the second sub-channels. In some embodiments, the system further includes one or more sources of optical monochromatic wave, each source emitting a monochromatic wave of a different wavelength and one or more modulators, each modulator operative to modulate an amplitude of one of the optical monochromatic waves in response to the signal before the optical monochromatic wave is multiplexed by the WDM, such that the optical monochromatic waves represent the signal.

In some embodiments, the system further includes one or more antennas configured to receive the signal, each antenna transferring the signal to one of the one or more modulators associated therewith.

In some embodiments, the system further includes one or more up-convertors, each up-converter configured to receive a respective signal including an in-phase component and a quadrature component, and each up-converter transferring the respective signal to one of the one or more modulators associated therewith. In some embodiments, the system further includes an antenna operative to emit a signal produced from a photocurrent from a balanced photodiode of the first sub-channel, and a photocurrent from a balanced photodiode of the second sub-channel.

In some embodiments, the system further includes a network of down-converters operative to construct an in-phase component and a quadrature component from a signal from a balanced photodiode associated with the first sub-channel, and the signal from a balanced photodiode associate with the second sub-channel. In some embodiments, the network of down-converters includes at least one down-converter positioned between the WDM and each of the one or more channels.

In some embodiments, at least one of the first optical modulators and the second optical modulators is based on a microring resonator.

In accordance with embodiments there is provided a method for beamforming a signal with a bank of optical modulators including one or more channels. The method includes receiving a monochromatic wave carrying the signal at a first sub-channel, the first sub-channel configured as a real-part sub-channel, the first sub-channel including a first waveguide and first optical modulators, each first optical modulator modulating an amplitude of the monochromatic wave carrying the signal with a real part of a complex number, the complex number having an associated phase. The method further includes receiving the monochromatic wave carrying the signal at a second sub-channel, the second sub-channel configured as an imaginary-part sub-channel, the second sub-channel including a second waveguide and second optical modulators, each second optical modulator modulating the amplitude of the monochromatic wave carrying the signal with an imaginary part of the complex number. The method additionally includes combining the modulated monochromatic wave associated with the first sub-channel and the modulated monochromatic wave associated with the second sub-channel, resulting in the signal being shifted with the phase of the complex number.

In some embodiments, each first sub-channel includes a balanced photodiode incoherently detecting monochromatic waves upon modulation in the respective first sub-channel and wherein each second sub-channel includes a balanced photodiode incoherently detecting monochromatic waves upon modulation in the respective second sub-channel.

In some embodiments, the method further includes comprising transmitting, by a wavelength division multiplexer (WDM), multiplexed monochromatic waves to each of the first sub-channels and each of the second sub-channels.

In some embodiments, the method further includes emitting a monochromatic wave of a different wavelength and modulating an amplitude of one of the optical monochromatic waves in response to the signal before the optical monochromatic wave is multiplexed by the WDM.

In some embodiments, the method further includes receiving the signal, and each antenna transferring the signal to one of the one or more modulators associated therewith.

In some embodiments, the method further includes receiving, by an up-converter, a respective signal including an in-phase component and a quadrature component, and each up-converter transferring the respective signal to one of the one or more modulators associated therewith.

In some embodiments, the method further includes emitting by an antenna, a signal produced from a photocurrent from a balanced photodiode of the first sub-channel, and a photocurrent from a balanced photodiode of the second sub-channel.

In some embodiments, the method further includes constructing an in-phase component and a quadrature component from a signal from a balanced photodiode associated with the first sub-channel, and the signal from a balanced photodiode associate with the second sub-channel.

### BRIEF DESCRIPTION OF THE DRAWINGS

FIG. 1 is a schematic diagram illustrating examples of an array of antennas can be used for beamforming, in accordance with embodiments of the present disclosure.

FIG. 2 is a schematic diagram illustrating a general architecture for an analog beamforming, in accordance with embodiments of the present disclosure.

FIG. 3 is a schematic diagram illustrating a general architecture for a digital beamforming architecture, in accordance with embodiments of the present disclosure.

FIG. 4 is a schematic diagram illustrating a hybrid beamforming architecture, in accordance with embodiments of the present disclosure.

FIG. 5 is a schematic diagram illustrating an architecture with MZMs operative to apply phase shifting to distinct propagation paths.

FIG. 6 is a schematic diagram illustrating a phased array of antennas, receiving an incoming signal, in accordance with embodiments of the present disclosure.

FIG. 7A is a schematic diagram illustrating a dual bus microring resonator (MRR) under bias voltage, in accordance with embodiments of the present disclosure.

FIG. 7B is a schematic diagram illustrating a transmission spectrum for a dual bus MRR, in accordance with embodiments of the present disclosure.

FIG. 8 is a schematic diagram illustrating a fully-connected optical beamforming receiver in an uplink scenario, based on complex Cartesian weighting, in accordance with embodiments of the present disclosure.

FIG. 9A is a schematic diagram illustrating graphically the intensity of an output signal from an MRR, in accordance with embodiments of the present disclosure.

FIG. 9B is a schematic diagram illustrating graphically the quantized intensity of an output signal from an MRR, in accordance with embodiments of the present disclosure.

FIG. 9C is a schematic diagram illustrating graphically a grid of complex weights for 1 GHz RF signals, in accordance with embodiments of the present disclosure.

FIG. 9D is a schematic diagram illustrating graphically a grid of complex weights for 10 GHz RF signals, in accordance with embodiments of the present disclosure.

FIG. 10 is a schematic diagram illustrating a fully-connected optical precoding transmitter in a downlink scenario, based on complex Cartesian weighting, in accordance with embodiments of the present disclosure.

FIG. 11 is a schematic diagram illustrating a generic fully-connected optical beamforming receiver, in accordance with embodiments of the present disclosure.

FIG. 12 is a schematic diagram illustrating a fully-connected optical beamforming receiver with optical frequency down-conversion, in accordance with embodiments of the present disclosure.

FIG. 13 is a block diagram of a method for beamforming a signal with a bank of optical modulators including one or more channels, in accordance with embodiments of the present disclosure.

It will be noted that throughout the appended drawings, like features are identified by like reference numerals.

### DETAILED DESCRIPTION

Beamforming is a signal processing technique by which transmitted or received signal power at an antenna array is spatially formed to create a directional link between a base station (BS) and a user equipment (UE). By nature of electromagnetic waves, when a single antenna radiates a signal (or signals), the signal is emitted in all directions. Having multiple antennas can provide an opportunity to direct a signal in one or more specific directions, i.e., to form a targeted beam of electromagnetic energy. The overlapping waves emitted by the multiple antennas can produce interference that in some directions is constructive (e.g. making the signal stronger) and in other directions is destructive (e.g. making the signal weaker, or undetectable). If executed correctly, a beamforming process can be designed to form a signal according to a selected pattern, such as a pattern having a preponderant direction.

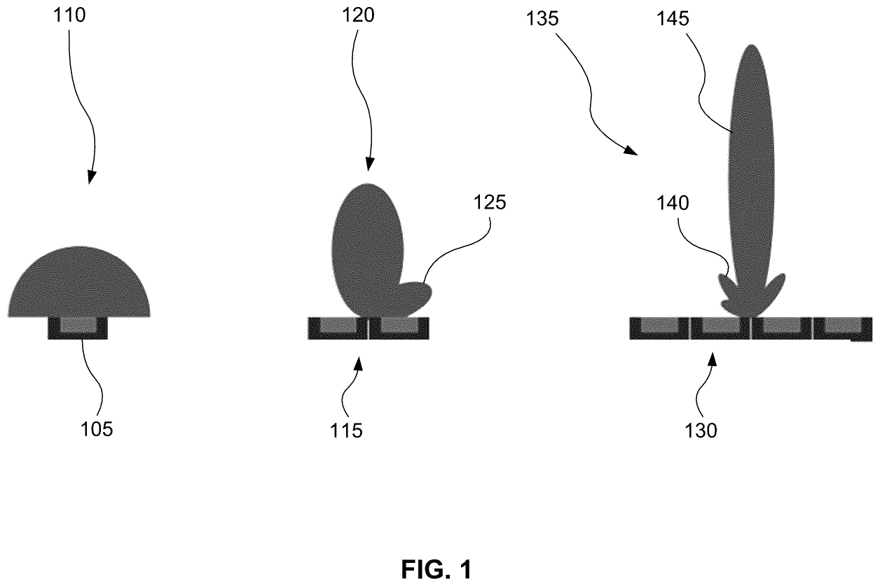

FIG. 1 illustrates how an array of antennas can be used for beamforming, according to an embodiment. With a single antenna 105, a beam 110 is emitted in all directions. With an array of two antennas 115, a beam 120 is made from two beams that interfere destructively and constructively. Thus the resulting beam includes an additional lobes 125. With an array of four antennas 130, a beam 135 is made from 4 beams interfering destructively and constructively. Therefore the resulting beam can include an increased number of side lobes 140. A plurality of lobes provides an opportunity to finely shape the overall beam, by tuning a phase shift applied at each antenna. In particular, the phases can be adjusted for one of the lobes to be highly directed 145, for example towards a target receiver.

In a scenario with a single path between a transmitter and a receiver, multiple radiating elements can transmit the same signal at the same frequency (or wavelength), but with different phases, such that the strength of the combined signal received along a specific direction or receiver can be enhanced. With such beamforming, the quality of a received signal can be greater, information can be received faster, errors can be reduced, and there is less need for boosting or amplification of the broadcast power.

For mmWave beamforming, there are generally three basic architectures. These basic architectures include analog beamforming, digital beamforming, and hybrid beamforming, which is a combination of analog beamforming and digital beamforming.

Analog beamforming can be implemented by a phased array with a single radio-frequency (RF) chain driven by a digital-to-analog converter (DAC) in a transmitter, or an analog-to-digital converter (ADC) in a receiver. In a phased array, antenna weights can be constrained for applying phase shifts that can be controlled using analog components. The phases of the phase shifters can typically be quantized to have a limited resolution, and can be adjusted based on specific strategies for steering the resulting beam.

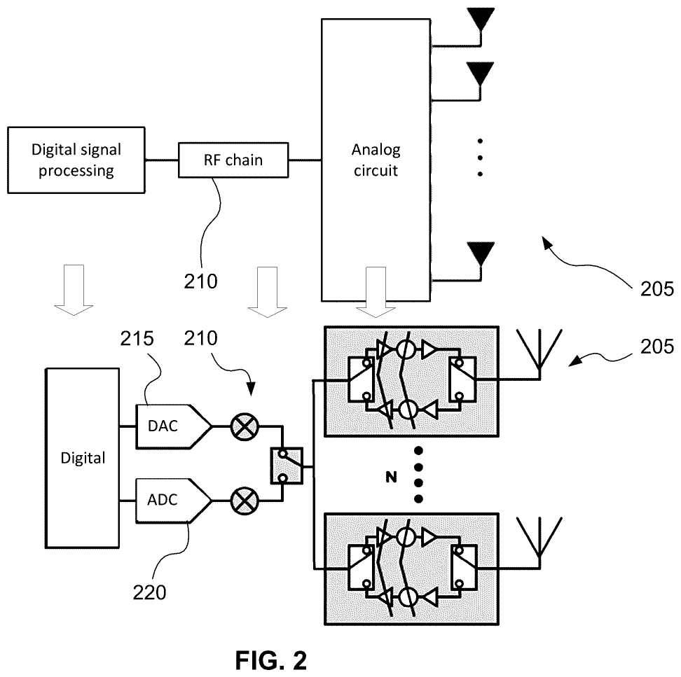

FIG. 2 illustrates a general architecture for analog beamforming, according to an embodiment. A phased array 205 can be driven with a single radio-frequency (RF) chain 210, driven by a DAC 215 in a transmitter, or by an ADC 220 in a receiver.

With digital beamforming, one RF chain can be allocated to each antenna of an array. In terms of signal processing, this can make digital beamforming more flexible than analog beamforming. Weighing and phase shifting of the antenna signals can be performed in a digital signal processing (DSP) unit.

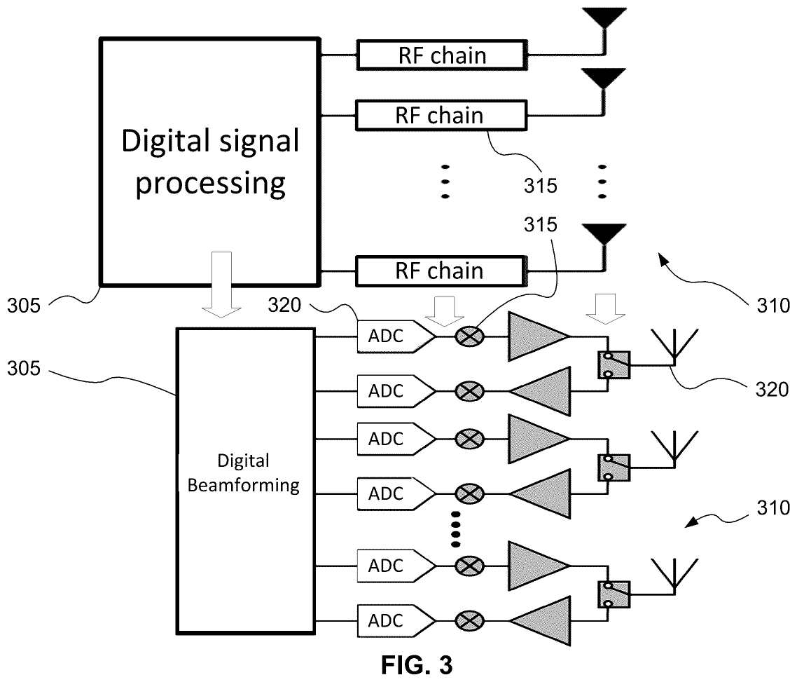

FIG. 3 illustrates a general digital beamforming architecture, according to an embodiment. A digital signal processing (DSP) unit 305 can perform weighing and phase shifting of the signals emitted by an array of antennas 310. Each antenna can be connected to the DSP via a dedicated RF chain 315 which includes an ADC 320.

Hybrid beamforming can provide improvements over both analog and digital beamforming architectures. Hybrid beamforming involves a two-stage beamforming architecture, constructed by concatenating a low-dimensional digital baseband beamformer, and an RF analog beamformer, implemented with phase shifters. In a multi-user massive MIMO system, a hybrid beamforming architecture can be beneficial as it offers concurrent support of multiple data streams at a lower cost, and a lower complexity, over digital beamformers.

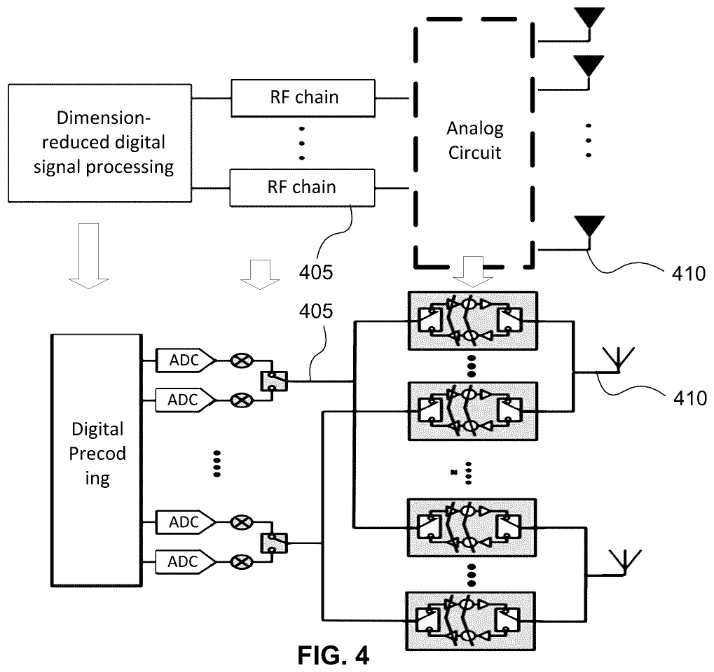

FIG. 4 illustrates a hybrid beamforming architecture, according to an embodiment. By having the output from each RF chain 405 connected to all the antenna elements 410, the architecture can be used to implement “fully-connected” hybrid beamforming. A hybrid beamforming architecture that is not fully-connected is referred to as “partially-connected”, in that the output of each of the RF chains is connected to some of the antenna elements, but not necessarily all of the antenna elements.

An alternative solution to an electronic-based architecture can be using photonics-based beamforming techniques, which incorporate RF-to-optical and optical-to-RF converters at the beamformer interfaces. By implementing optical technologies on integrated circuits, a beamformer can have a small size, low weight, low insertion loss, and can potentially have low production and installation costs. Generally, RF photonic signal processing techniques for beamforming applications can provide performance benefits over electronic approaches, such as tunability, high bandwidth, and a compact form factor. Furthermore, photonic circuits are immune to electromagnetic interference and have lower propagation losses in silicon waveguides.

Optical beamforming can be performed using phased array receivers having complex (e.g., dual-drive or dual-parallel) Mach-Zehnder modulator (MZM) architectures, and true time delays in place of phase shifters.

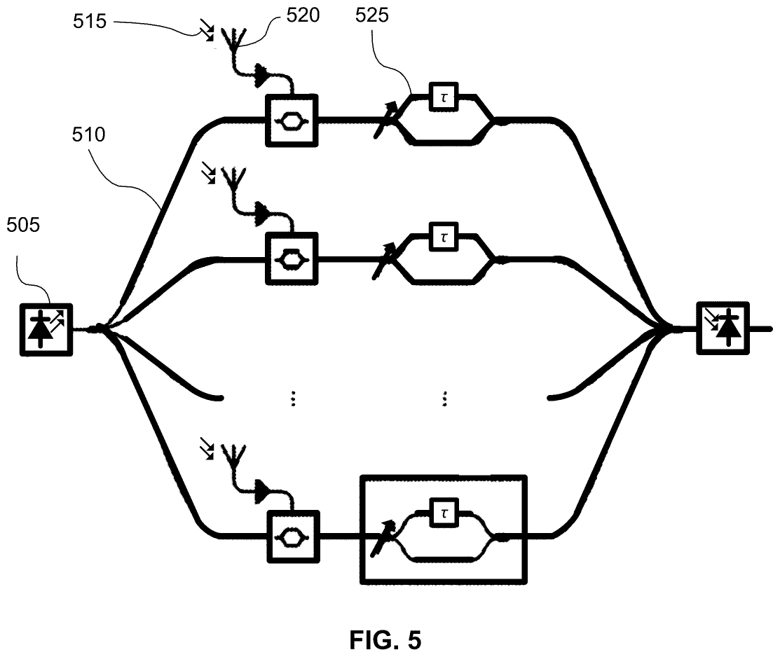

FIG. 5 illustrates an architecture with MZMs operative to apply phase shifting to distinct propagation paths. A signal from a receiver 505 can be split into a plurality of paths 510, each one operative to receive a signal 515 from an antenna 520 and apply a true time delay with an MZM 525.

In a massive mmWave MIMO 5G or 6G system, a precoder at the transmitter and a combiner at the receiver can guarantee that signals have the required strength (e.g. power level) in a specific direction to be correctly received and processed by a target receiver in that direction. An electronic beamformer architecture can suffer from high power consumption, high insertion losses, and high signal processing complexity, which can increase with the number of BS antennas and the number of users associated with the networks. Moreover, existing optical RF beamformers often require a complex and costly optical architecture with a large footprint, precluding them to be scaled with a massive number of BS antennas and with a network having a large number of data streams.

Embodiments include a fully-connected optical beamforming architecture for precoding signals in RF transmitters, combining signals in RF receivers, and precoding and combining signals in RF transceivers. An objective of embodiments is to implement the analog portion of a hybrid beamformer in the optical domain to realize benefits of size and reduced insertion loss over electronics-based implementations, while resolving technical challenges of existing optical beamforming. Furthermore, a fully-connected architecture according to embodiments can exploit the high bandwidth, low insertion loss, and low power consumption of optical technologies.

In an embodiment, optical beamforming system can be performed by channelizing RF signals to be transmitted or received on an optical waveguide, using wavelength division multiplexing (WDM), and phase shifting the signals can be performed with complex Cartesian weighing, using photonic spectral filters.

In an embodiment, optical beamforming is implemented in an uplink scenario wherein UEs transmit their signals to a BS through a single transmission path. A combiner can be utilized in RF transceivers with any number of antennas at the BS and any number of transmitting users.

In a phased array of antennas according to an embodiment, since the propagation paths from a transmitter to different elements of a receiving antenna can differ, an RF signal received by one antenna can experience a phase shift, relative to an RF signal received at an adjacent antenna. In order to combine the received signals constructively, for example with constructive interference, the signals received at different antennas can be actively phase shifted at the source, according to the passive phase shifts resulting from the different propagation paths of each signal received.

A transmitted RF signal having a peak amplitude A, a carrier frequency f_{RF}, and a phase 4, can be represented by an amplitude (e.g. the magnitude of an electric field) as a function of time x(t) as defined in Equation 1.

x(t)=A cos(2πf_{RF}t+φ) (1)

If a signal's angle of arrival at an array of antennas is θ, then the phase shift Δφ between two beams of wavelength λ, wherein each beam is a part of the signal received by adjacent antennas placed at distant d from each other can be determined using Equation 2, 3 and 4.

$$sin θ = \frac{Δφ}{d} \qquad ( 2 )$$

Δφ=md sin θ, m∈ [symbol] , mλ=2π (3)

$$Δφ = 2 π \frac{d sin θ}{λ} \qquad ( 4 )$$

Accordingly, the phase of a signal xᵢ(t) received at the i^{th} antenna can be shifted compared to a signal xᵢ₋₁(t) received at the (i−1)^{th} antenna, by an amount (i−1)Δφ, such that the signal received at the (i−1)^{th} antenna can be defined by Equation 5.

xᵢ₋₁(t)=A cos[2πf_{RF}t+φ+(i−1)Δφ] (5)

This can provide the details, namely the phase shift required for the signals at the i^{th} and (i−1)^{th} antennas to be combined constructively. In an embodiment, different approaches can be used to apply such phase shifting to a received signal, including an approach using complex Cartesian weights.

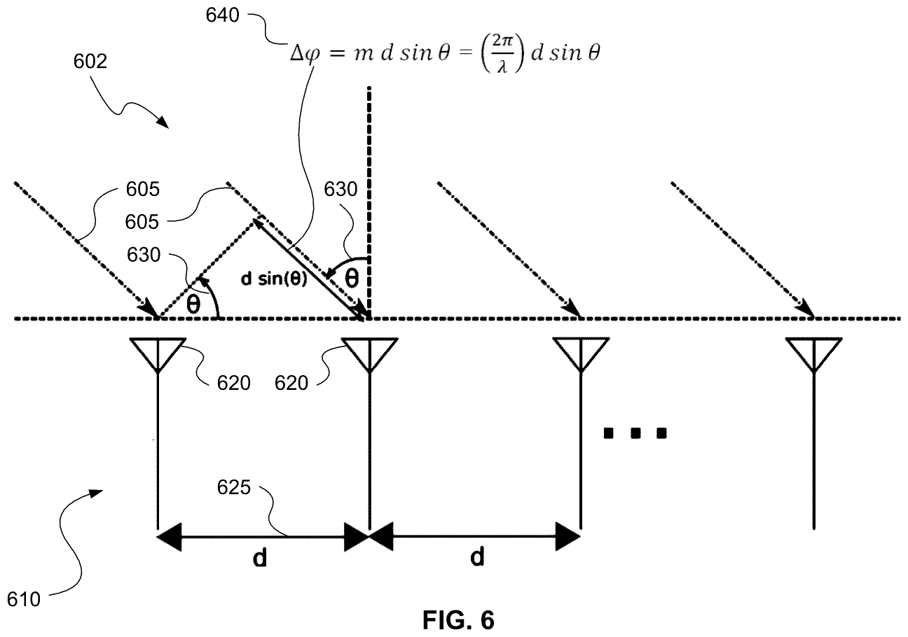

FIG. 6 illustrates a phased array of antennas, receiving an incoming signal, according to an embodiment. An incoming signal 602 can be received as multiple beams 605, by an array 610 of multiple antennas 620 (i.e. antenna elements), each antenna 620 separated from its neighbouring antenna by a distance d 625. The angle of arrival for each beam can be e 630, making the phase difference Δφ 635 between each beam a multiple of d sin e 640.

In an approach using complex Cartesian weights, a part of a signal related to a kth data stream can be received by an l^{th} antenna. A phase change φₗₖ can be selected and realized, by separating the received signal into two signals and multiplying each of these two signals by with a scalar, wherein the scalar has a real part (Re) and an imaginary part (Im) of a complex number defined as Aₗₖ=Re(Aₗₖ)+j Im(Aₗₖ), which is defined such that Equations 6 and 7 below are satisfied.

$${φ}_{lk} = {tan}^{- 1} [ \frac{Im ( {A}_{lk} )}{Re ( {A}_{lk} )} ] \qquad ( 6 )$$

and:

\sqrt{[Re(Aₗₖ)]²+[Im(Aₗₖ)]²}=1 (7)

In a fully-connected beamforming architecture according to an embodiment based on complex Cartesian weighing, a real coefficient Re(Aₗₖ), and an imaginary coefficient Im(Aₗₖ), can be applied to a signal, by using photonic spectral filters, such as optical microring resonators (MRR). Embodiments can also be used with other spectral filters, such as Bragg gratings, photonic crystals, cascaded Mach-Zehnder interferometers, and others.

In an embodiment, an MRR weight bank can be used to implement complex Cartesian weights. An MRR weight bank can include a sequence of dual bus MRRs, each one carrying out a Lorentzian shaped transfer function between its input port and its drop port, and a complimentary Lorentzian shaped transfer function between its input port and through port. The two output signals of an MRR, or of a sequence of MRRs, can be detected at a balanced photodetector, which can produce a photocurrent proportional to the difference between the through port output(s) and the drop port output(s). This can result in applying an effective weight (i.e. a multiplying factor) to the signal in the range of (−1, 1), depending on the signal's wavelength relative to the resonant peak of the MRR. By tuning a current applied to an MRR, the resonant wavelength of the MRR can be shifted, which can enable the tuning of the weight applied to the MRR's output signals. The shifting of an MRR's resonant wavelength can be realized by changing the resonant condition when the effective refractive index of the waveguide core is modulated by using, for example, a thermal heater or a PN-junction.

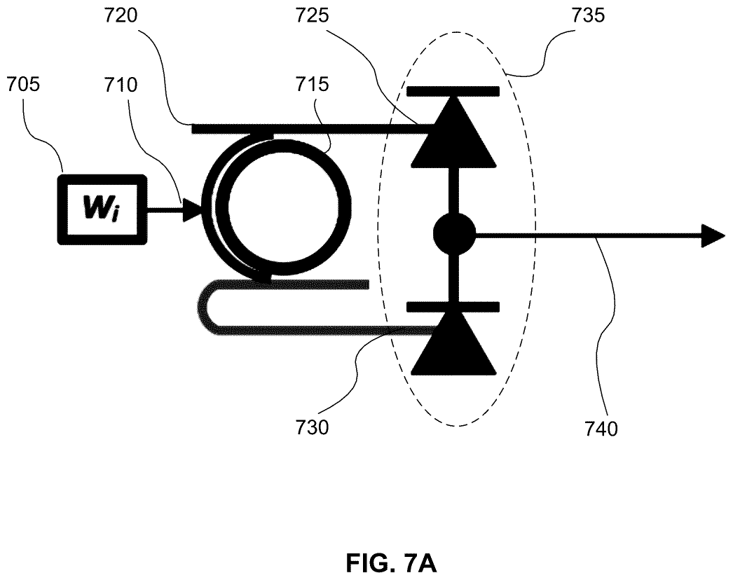

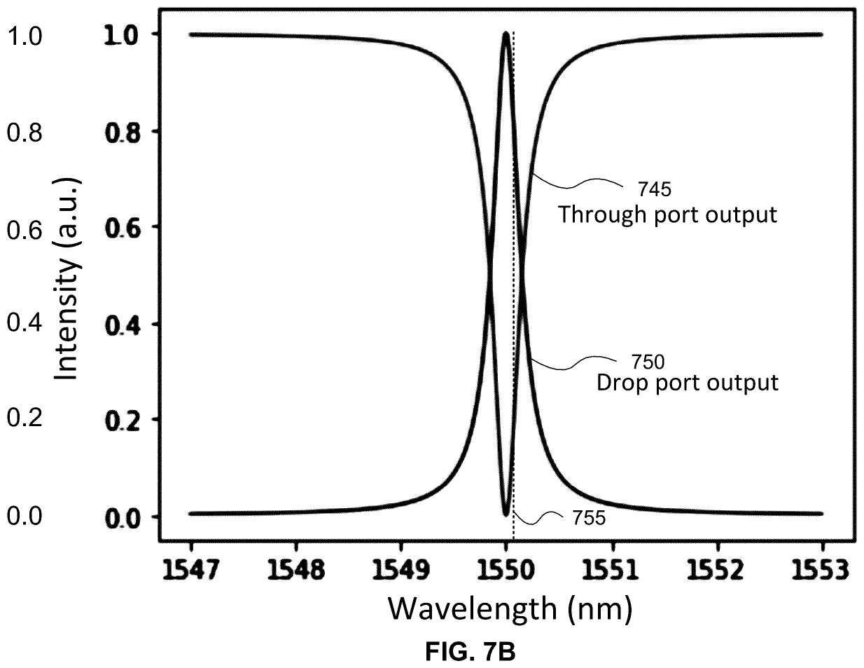

FIG. 7A illustrates a dual bus microring resonator (MRR) under bias voltage, according to an embodiment. A voltage or a current can be applied to a modulating device 705, operative to implement a free-carrier plasma dispersion effect, a thermo-optic effect, or another effect that can modulate 710 the refractive index of an MRR 715, and thereby produce a tunable through port output signal 725 and a tunable drop port output signal 730 from an input signal 720. A balanced photodetector (PD) 735, typically made of two properly connected photodetectors, can collect the output optical signals and produce an electronic signal 740 representing a product between the voltage or current applied at the modulating device 705, and the input intensity 720, which can be considered a weighted signal. In a balanced PD, each PD within the balanced PD can accumulate light signals of a sub-channel, and convert the complete, summed signal to one summed electrical signal. The two PDs can subsequently perform a subtraction, which can allow an output signal to be in a range including negative and positive values.

FIG. 7B is a transmission spectrum for a dual bus MRR, according to an embodiment. The effect of an MRR 715 is to produce from an input signal 720 a through port output signal 725 and a drop port output signal 730. As a function of wavelength, each output is centered on a wavelength defined by the MRR's circumference and refractive index, the latter of which can be modulated indirectly by a current, via a modulation device 705 operating one of various mechanisms as further defined elsewhere herein. The two outputs have complimentary Lorentzian linewidths, one for the through port output 745 and one for the drop port output 750. By modulating an MRR's refractive index, the central output wavelength 755 can be shifted while their maximum intensity can remain within the Lorentzian profiles. This effectively applies a weight (e.g. an amplitude change) to a passing optical signal.

In an optical beamforming architecture according to embodiments, such as a fully-connected architecture, when an RF signal is received by an array of antennas, each antenna can modulate (e.g. apply a weight) to its corresponding received signal, wherein each antenna can modulate the received signal at a different optical wavelength producing differently modulate optical signals. Then, these differently modulated optical signals can be multiplexed into a single waveguide. If wavelength selective modulators are used, such as modulated MRRs, the optical signals can be multiplexed prior to modulation.

In an embodiment, single sideband optical modulation can be used in order to reduce the bandwidth of an optical signal. In another embodiment, double sideband modulation can be used. Double sided modulation can be used if the RF signal's carrier frequency is sufficiently small. Depending on the sensitivity requirements of a receiver, a low-noise amplifier can be used to amplify a signal received before modulation.

In an uplink scenario, after a signal (i.e. a data stream), or part of a signal, is received at an antenna, it can undergo an initial wavelength amplification and modulation, and then be multiplexed. After multiplexing, a signal can be split into two parts. A first part can represent an in-phase component and the other part can represent a quadrature component. A combiner according to embodiments can be used to obtain complex weights, which can be applied to the two parts of the signal using MRR weight banks. These weight banks can be analogous to variable gain amplifiers with a tuning range of (−1, 1).

Once weighted, each part of a signal can be detected incoherently, with a balanced photodetector, producing a photocurrent that represents a weighted sum of the received RF signals, carried at different wavelengths. The in-phase and quadrature components of the transmitted signal can be constructed after a multi-step frequency down-conversion stage during which the signal is converted from an RF signal to at least one intermediate frequency (IF) signal, and from an IF signal to a baseband (BB) signal. In other embodiments, frequency down-conversion can be performed in a single step, with direct conversion from a RF signal to a BB signal.

In a radio architecture according to an embodiment, frequency down-conversion is a technique that can be used for translating an RF signal down to a signal having a fixed intermediate frequency (IF) signal or to baseband (BB) frequency signal. A down-converter (for example a mixer) can work by multiplying the signal of interest (e.g. RF signal) with a local oscillator (LO), producing two signals, a first signal with frequency f₁=f_{RF}+f_{LO} and a second signal with frequency f₂=f_{RF}−f_{LO}. An upper sideband at frequency f₁ can be filtered out of these signals so that the down-converter's output is a copy of the input signal (e.g. the signal of interest) shifted down to a lower frequency f₂. Frequency down-conversion can be implemented in the analog domain using optical or electronic components, or in a digital signal processor (DSP). However, digital down-conversion may be limited by the sampling rate of an ADC and as such in a mmWave receiver, analog frequency conversion may be required.

In an embodiment, an electronic down-converter (e.g. a mixing circuit, an RF mixer, or mixer) can be used. The electronic down-converter can be configured as a 3-port device that takes the RF signal and the LO signal as inputs and produces the sum and/or difference of these frequencies as an output. An electronic down-converter can be implemented using nonlinear devices such as diodes and field-effect transistors, and an electronic down-converter may further amplify of the output signal. An unbalanced RF mixer can be realized by combining and injecting the RF signal and the LO signal at the input of a single diode. An LO signal can switch a diode between its ON state and OFF state, thereby gating the RF signal to the output at the LO signal's frequency. This type of passive mixer can have a high dynamic range, but the performance can be affected by high conversion loss, poor inter-port isolation, and spurious emissions as the input RF signal and LO signal are not suppressed at the output.

In an embodiment, a balanced mixer can also be used as an electronic down-converter. A balanced mixer is a circuit topology that uses multiple nonlinear devices with inputs applied through a balanced circuit so that one or both of the inputs are suppressed at the output. This configuration of an electronic down-converter can reduce spurious emissions and improve the isolation between the RF and LO ports.

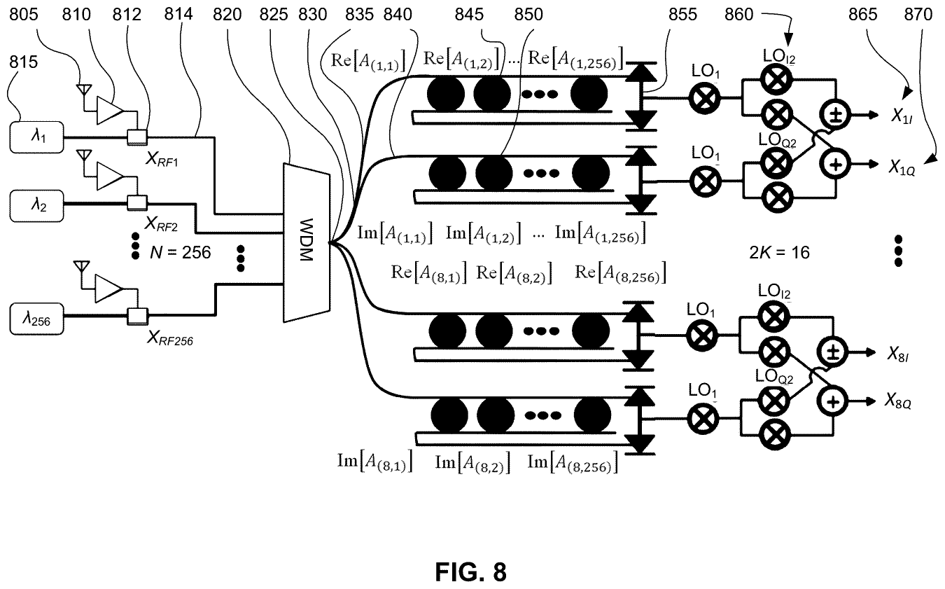

FIG. 8 illustrates a fully-connected optical beamforming receiver, based on complex Cartesian weighting, according to embodiments. As an example, an array of 256 antennas 805 can receive a signal. For each antenna, a low noise amplifier (LNA) 810 can amplify a signal received so that it can modulate 812 an optical wavelength 815 to optically carry the signal in a waveguide 814. The signals from each antenna can be multiplexed at a WDM 820 onto a same waveguide 825, which can be split into different waveguide channels 830. Each channel can be associated with a data stream (or user), however each channel can be further split into two sub-channels. These two sub-channels include an in-phase sub-channel 835 and a quadrature sub-channel 840, each of these sub-channels associated with the same data stream (or user). At each sub-channel, the real part 845 or imaginary part 850 of a complex number, can be applied to each wavelength of the sub-channel.

For example, a first sub-channel can be configured as a real-part sub-channel that includes a first waveguide and a series of optical modulators (e.g. MRRs) along the waveguide. Each modulator can be operative to modulate an amplitude of a monochromatic wave carrying the signal with a real part of a complex number, wherein the complex number represents an associated phase. A second sub-channel can be configured as an imaginary-part sub-channel that includes a second waveguide and a series of optical modulators operative to modulate the amplitude of a monochromatic wave carrying the signal with an imaginary part of the same complex number.

In embodiments, channels and respective sub-channels can be configured to be in parallel and can be configured to propagate the same signal or different signals in parallel.

According to embodiments, there is provided a set of parallel waveguide channels and/or sub-channels, where each channel or sub-channel has an input beam including many optical monochromatic waves, and as a series of optical modulators. Each optical modulator can be operative to modulate the amplitude of one of the many monochromatic waves forming the signal, can be referred to as a weight bank.

Once two complementary sub-channels have been modulated, their combination can result in the signal being shifted with the phase of the complex number. In other words, a modulated monochromatic wave associated with the first sub-channel and a modulated monochromatic wave associated with the second sub-channel can result in a monochromatic wave that is phase-shifted with the phase of the complex number. Similarly, for a beam including many monochromatic waves and waveguides including many modulators, a combination of respective real and imaginary parts can result in a signal that is phase-shifted according to the respective complex numbers.

For example, at each sub-channel, a modulated signal can be incoherently detected at a balanced photodetector 855, such that the resulting output current represents a weighted sum of the RF signals. The RF signals associated with each of the antennas can be fully-connected. Before combination of real-part signals with imaginary-part signals, each pair of sub-channels, local oscillators 860 can be configured as a down-converter, which enables the resulting signals to undergo a quadrature down conversion stage converting the signal into as intermediary frequency (IF) signal and the baseband (BB) frequency signal, in two steps. And subsequently construct the in-phase 865 and quadrature 870 components of the signal.

In order to attempt to optimize the precision of the complex weights and to reduce the amplitude attenuation of a beamforming network, calibration and quantization can be important considerations. A uniform quantization of the power transmitted through the MRRs, between their ON and OFF resonance states, can produce, at low carrier frequencies, a uniformly quantized complex weight over a square grid.

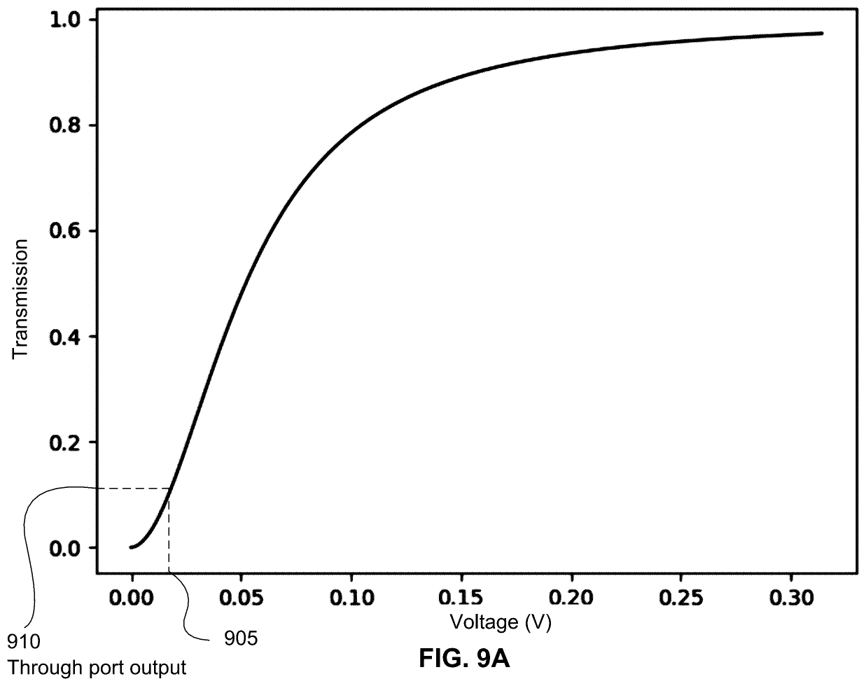

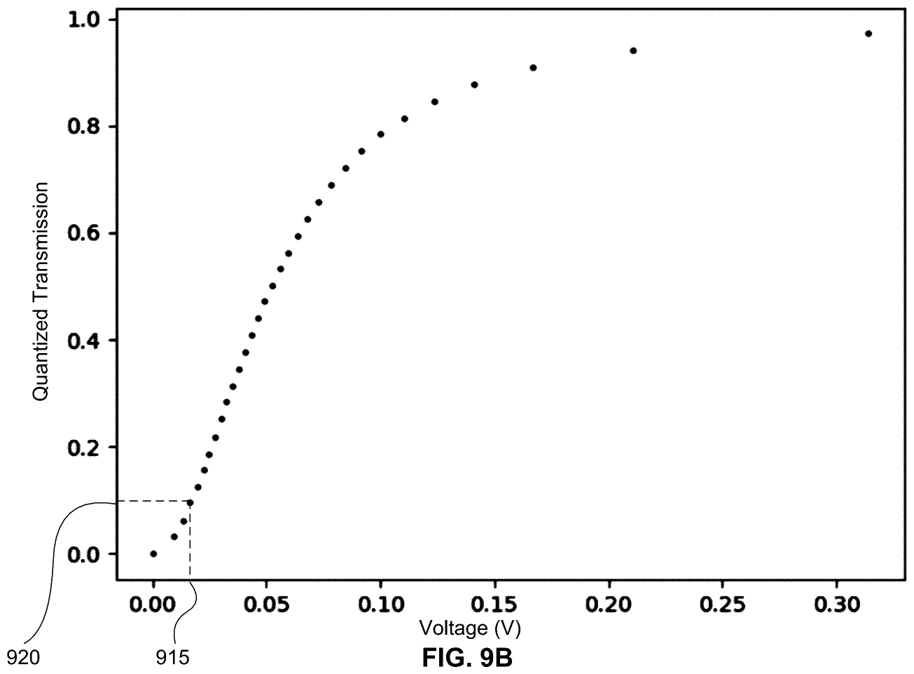

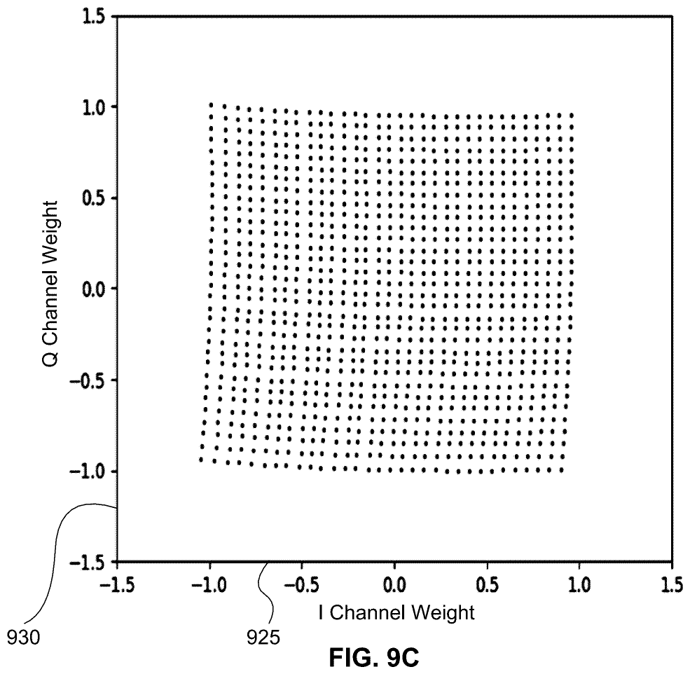

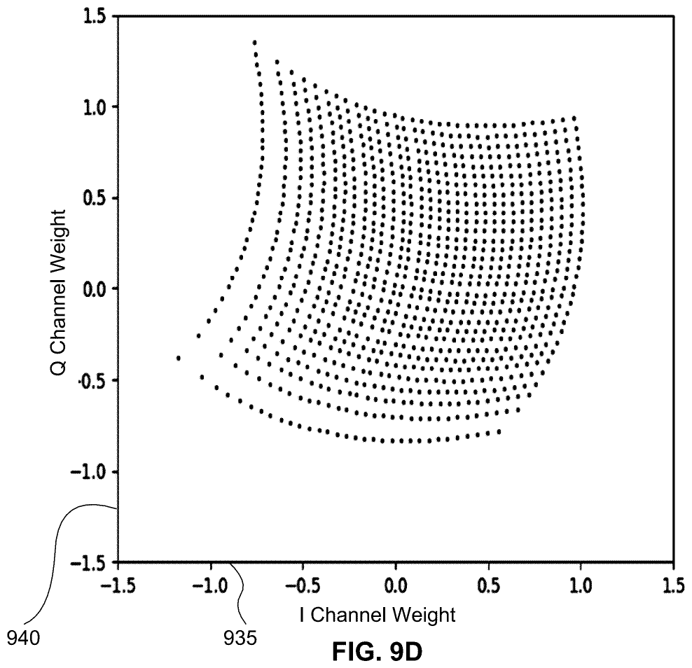

In an embodiment, a uniform quantization of the power transmitted through an MRR, between ON and OFF resonance states can produce a uniformly quantized complex weight over a square grid at low RF carrier frequencies. A look-up table can then be formed by imposing a constant modulus constraint on the complex weights and discarding all values falling outside a tolerable level of ripple. A comparison between FIG. 9A and FIG. 9B illustrates what quantization refers to as further discussed below.

FIG. 9A is a graph showing the intensity of an output signal from an MRR, according to embodiments. As a current or voltage 905 is applied to an MRR modulator, the transmission 910 of an input signal, as measured at the drop port 730, can be weighted from 0 to 1.

FIG. 9B is a graph showing the quantized intensity of an output signal from an MRR, according to embodiments. Instead of being from a free range of continuous values, a current or voltage applied to a modulator 705 can be limited to discrete values 915, such that the transmitted intensity is also quantized 920.

A grid of the quantized, in-phase weights and quadrature weights can be made and at lower frequencies, such as 1 GHZ, such a grid can have values that are generally aligned.

FIG. 9C is a graph showing a grid of complex weights for 1 GHz RF signals, according to embodiments. In-phase weights can be represented by an x-axis 925, and quadrature weights can be represented on a y-axis 930.

For higher RF frequencies, such as 10 GHZ, a similar grid can appear distorted, because there can be a large offset between an optical sideband and the carrier signal.

FIG. 9D is a graph showing a grid of complex weights for 10 GHz RF signals, according to embodiments. In-phase weights can be represented on an x-axis 935, and quadrature weights can be represented on a y-axis 940. According to embodiments, in order to alleviate this distortion, down-conversion of the RF signal (as discussed elsewhere herein) can be applied thereby reducing the frequency of the RF signal and mitigating the distortion illustrated in FIG. 9D.

In embodiments, optical components can be realized with photonic integrated circuitry (e.g. optical chips). This can allow a beamformer to have a small size, low weight, low insertion loss, and potentially a low cost of production and installation. The application of WDM to channelize RF signals for parallel processing in MRR weight banks can enable a scalable and compact beamforming architecture that can be extended to support multiple data streams concurrently. Embodiments of the instant disclosure employ complex weighing, which allows implementation in a hybrid beamforming system. While prior art optical beamforming technologies perform RF phase shifting with true time delays.

Moreover, in contrast to optical beamforming approaches of the prior art, with which a fully-connected system would be highly complex, require significant power consumption by RF transceivers, embodiments of the instant disclosure have greater scalability and power efficiency, and can provide opportunities to construct a fully-connected beamforming architecture, where all data streams are connected to all the antennas.

In an embodiment, an optical architecture can be used as a combiner for RF receivers in an uplink scenario. In other embodiments, a similar optical system can be used in a downlink scenario to implement precoding at a transmitter side.

In a downlink scenario, a BS can have N antennas and serve K users. Electronic BB signals in a series of data streams can be up-converted and modulated with optical carriers at K different wavelengths, and then be multiplexed onto a single waveguide. The output channels from the WDM are associated with the number of antennas and each channel has two sub-channels, wherein one represents the in-phase component and the other the quadrature component of the signal which are going to be transmitted from each antenna. As such, this results in a total of 2N parallel channels. Multiplexed signals can be inputs to MRR weight banks tuned to apply complex weights according to a given precoder design. The weighted signal in each arm can then be detected incoherently by a balanced photodetector so that the resulting photocurrent represents a weighted sum of the transmitted signals. The in-phase and quadrature components can be recombined, and then amplified and transmitted through the antenna array.

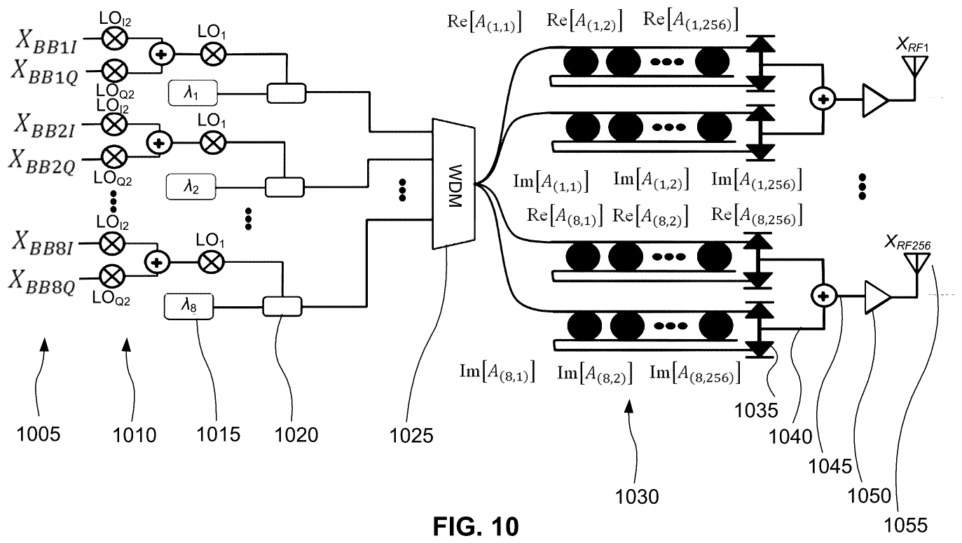

FIG. 10 illustrates a fully-connected optical precoding transmitter in a downlink scenario, based on complex Cartesian weighting, according to embodiments. As an example, 8 baseband signals 1005, X_{BB1} to X_{BB8}, each having an in-phase component and a quadrature component, e.g. X_{BB1}/and X_{BB1Q} can be up-converted by local oscillators configured as up-converters 1010. The signals can be modulated with optical carriers at 8 different wavelengths 1015, by modulators 1020. The signals can then be multiplexed by a WDM 1025 into twice the number of antennas (2*256), which can be 512 sub-channels such that a real-part weight and an imaginary-part weight can be applied by a weight bank 1030 to each one of the original 8 wavelengths. The weighted signal in each sub-channel (arm) can then be detected incoherently by a balanced photodetector 1035. A resulting photocurrent 1040 can represent a weighted sum of a signal. An in-phase component and a (π/2)-phase-shifted version of the quadrature component can recombine 1045, and a resulting signal can be amplified 1050 and transmitted via respective antennas of an array 1055.

An embodiment implementing precoding in a downlink scenario can provide a small size and power efficient architecture for precoding in a mmWave, massive MIMO system, which can efficiently be scaled with the number BS antennas and the number of users in a wireless communication system.

A fully-connected architecture according to embodiments can make use of MRRs to manipulate optical signal components in order to apply complex Cartesian weights to a received RF signal. In an embodiment, other kinds of modulators can be used instead of MRRs, individually or as a group, for a similar application. For example, a modulator can be based on LiBO₃, and/or EO-polymers.

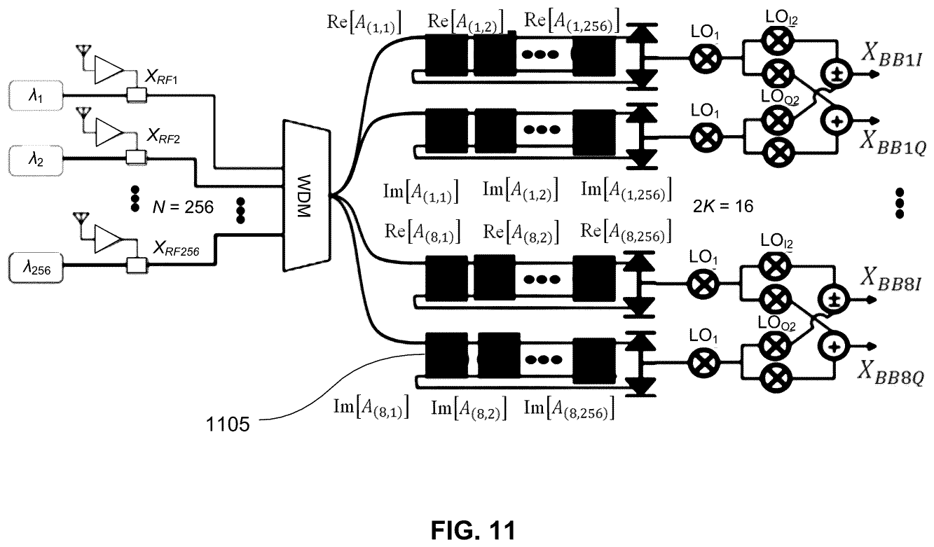

FIG. 11 illustrates a generic fully-connected optical beamforming receiver, according to an embodiment. Instead of MMRs, as can be used by embodiments represented by FIG. 8, a receiver can make use of another kind of modulator 1105.

A fully-connected architecture according to embodiments can be modified to perform intermediate frequency (IF) signal down-conversion, before complex weights are applied at the MRR weight banks. This can be achieved with optical frequency down-conversion, or with electrical down-conversion of the antenna signals, before optical modulation of the signal is performed.

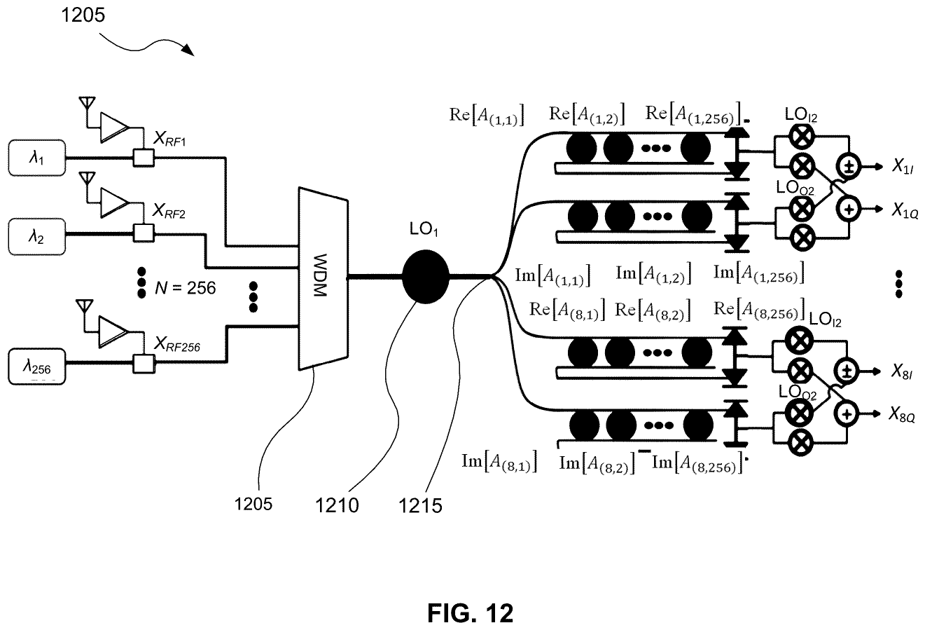

FIG. 12 illustrates a fully-connected optical beamforming receiver with optical frequency down-conversion, according to an embodiment. With reference to FIG. 12, an architecture 1205 similar to that illustrated and defined in relation to FIG. 8 can be used, while further including a local oscillator 1210, between the WDM and where the multiplexed signal's channel splits 1215.

In an embodiment where intermediate frequency (IF) down-conversion is performed prior to modulation by MRR weight banks, a signal's bandwidth can be reduced before complex weighting, which can relax the bandwidth requirements of the MRRs. Furthermore, with optical down-conversion, the WDM signals can be down-converted simultaneously, with a single local oscillator (LO). This can further reduce the size and complexity of a beamforming circuit and improve its scalability, for example to accommodate a greater a number of data streams.

Embodiments include a fully-connected optical beamforming architecture wherein phase shifting is performed with complex Cartesian weighting of a signal.

Embodiments include a photonics-based beamforming architecture leveraging the high bandwidth of optical components and waveguides, by channelizing antenna received signals on the same waveguide. In some embodiments, a signal from an antenna of an array of antennas, can be divided into two parts, and the signals of array of antennas (e.g. each of which have been divided into two parts) can be channelized on the same waveguide.

In embodiments, combining different parts of a signal transmitted or received by an array of antennas, can be realized by mixing photocurrents, after being incoherently detected in wavelength channels, rather than being coherently combined in the optical domain.

Embodiments include phase shifting different parts of an RF signal by applying complex weighting with optical modulators such as MRR weight banks.

Embodiments include combining different parts of an RF signal with incoherent detection, after the different parts of an RF signal have been wavelength division multiplexed.

A fully-connected optical beamforming architecture according to embodiments can be applied to a multi-user wireless communication system with multiple antennas (e.g. a massive number of antennas) at a transmitter and/or at a receiver. The architecture according to embodiments of the instant application can provide a beamforming approach for massive MIMO (mmWave) systems as this architecture can be scaled up to support many users and many antennas.

In embodiment, an optical monochromatic wave is an optical signal having a central wavelength, such as to be substantially monochromatic for practical purposes. A person of ordinary skill in the art will recognize that an optical monochromatic wave has a linewidth. In embodiments, an optical signal can include a plurality of monochromatic optical waves.

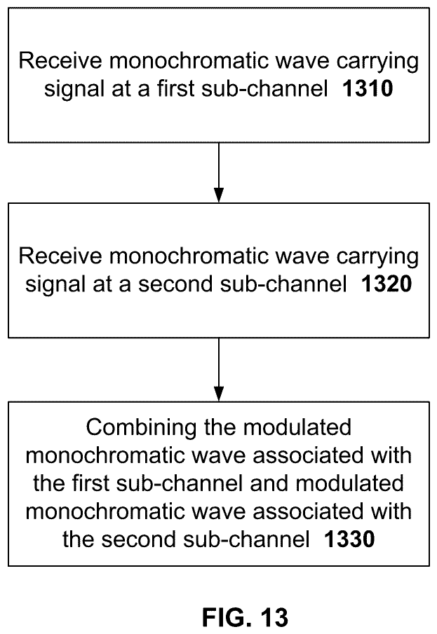

FIG. 13 illustrates a method for beamforming a signal with a bank of optical modulators including one or more channels, in accordance with embodiments of the present disclosure. The method includes receiving 1310 a monochromatic wave carrying the signal at a first sub-channel, the first sub-channel configured as a real-part sub-channel, the first sub-channel including a first waveguide and first optical modulators, each first optical modulator modulating an amplitude of the monochromatic wave carrying the signal with a real part of a complex number, the complex number having an associated phase. The method further includes receiving 1320 the monochromatic wave carrying the signal at a second sub-channel, the second sub-channel configured as an imaginary-part sub-channel, the second sub-channel including a second waveguide and second optical modulators, each second optical modulator modulating the amplitude of the monochromatic wave carrying the signal with an imaginary part of the complex number. In addition, the method includes combining 1330 the modulated monochromatic wave associated with the first sub-channel and the modulated monochromatic wave associated with the second sub-channel, resulting in the signal being shifted with the phase of the complex number.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A system for beamforming a signal, the system comprising one or more channels, each channel including:
a first sub-channel configured as a real-part sub-channel, the first sub-channel including a first waveguide and first optical modulators, each first optical modulator operative to modulate an amplitude of a monochromatic wave carrying the signal with a real part of a complex number, the complex number representing an associated phase; and
a second sub-channel configured as an imaginary-part sub-channel, the second sub-channel including a second waveguide and second optical modulators, each second optical modulator operative to modulate the amplitude of the monochromatic wave carrying the signal with an imaginary part of the complex number;
wherein combining the modulated monochromatic wave associated with the first sub-channel and the modulated monochromatic wave associated with the second sub-channel results in the signal being shifted with the phase of the complex number.

2. The system of claim 1, wherein the two or more channels and respective first sub-channel and second sub-channel are in parallel.

3. The system of claim 1, wherein each first sub-channel includes a balanced photodiode operative to incoherently detect monochromatic waves upon modulation in the respective first sub-channel and wherein each second sub-channel includes a balanced photodiode operative to incoherently detect monochromatic waves upon modulation in the respective second sub-channel.

4. The system of claim 1, further comprising a wavelength division multiplexer (WDM) configured to transmit multiplexed monochromatic waves to each of the first sub-channels and each of the second sub-channels.

5. The system of claim 4, further comprising
one or more sources of optical monochromatic wave, each source emitting a monochromatic wave of a different wavelength; and
one or more modulators, each modulator operative to modulate an amplitude of one of the optical monochromatic waves in response to the signal before the optical monochromatic wave is multiplexed by the WDM.

6. The system of claim 5, further comprising one or more antennas configured to receive the signal, each antenna transferring the signal to one of the one or more modulators associated therewith.

7. The system of claim 5, further comprising one or more up-convertors, each up-converter configured to receive a respective signal including an in-phase component and a quadrature component, and each up-converter transferring the respective signal to one of the one or more modulators associated therewith.

8. The system of claim 7, further comprising an antenna operative to emit a signal produced from a photocurrent from a balanced photodiode of the first sub-channel, and a photocurrent from a balanced photodiode of the second sub-channel.

9. The system of claim 4, further comprising a network of down-converters operative to construct an in-phase component and a quadrature component from a signal from a balanced photodiode associated with the first sub-channel, and the signal from a balanced photodiode associate with the second sub-channel.

10. The system of claim 9, wherein the network of down-converters includes at least one down-converter positioned between the WDM and each of the one or more channels.

11. The system of claim 1, wherein at least one of the first optical modulators and the second optical modulators is based on a microring resonator.

12. A method for beamforming a signal with a bank of optical modulators including one or more channels, the method comprising:
receiving a monochromatic wave carrying the signal at a first sub-channel, the first sub-channel configured as a real-part sub-channel, the first sub-channel including a first waveguide and first optical modulators, each first optical modulator modulating an amplitude of the monochromatic wave carrying the signal with a real part of a complex number, the complex number having an associated phase; and
receiving the monochromatic wave carrying the signal at a second sub-channel, the second sub-channel configured as an imaginary-part sub-channel, the second sub-channel including a second waveguide and second optical modulators, each second optical modulator modulating the amplitude of the monochromatic wave carrying the signal with an imaginary part of the complex number;
combining the modulated monochromatic wave associated with the first sub-channel and the modulated monochromatic wave associated with the second sub-channel, resulting in the signal being shifted with the phase of the complex number.

13. The method of claim 12, wherein the two or more channels and respective first sub-channel and second sub-channel are in parallel.

14. The method of claim 12, wherein each first sub-channel includes a balanced photodiode incoherently detecting monochromatic waves upon modulation in the respective first sub-channel and wherein each second sub-channel includes a balanced photodiode incoherently detecting monochromatic waves upon modulation in the respective second sub-channel.

15. The method of claim 12, further comprising transmitting, by a wavelength division multiplexer (WDM), multiplexed monochromatic waves to each of the first sub-channels and each of the second sub-channels.

16. The method of claim 15, further comprising
emitting a monochromatic wave of a different wavelength; and
modulating an amplitude of one of the optical monochromatic waves in response to the signal before the optical monochromatic wave is multiplexed by the WDM.

17. The method of claim 16, further comprising receiving the signal, and each antenna transferring the signal to one of the one or more modulators associated therewith.

18. The method of claim 16, further comprising receiving, by an up-converter, a respective signal including an in-phase component and a quadrature component, and each up-converter transferring the respective signal to one of the one or more modulators associated therewith.

19. The method of claim 18, further comprising emitting by an antenna, a signal produced from a photocurrent from a balanced photodiode of the first sub-channel, and a photocurrent from a balanced photodiode of the second sub-channel.

20. The method of claim 15, further comprising constructing an in-phase component and a quadrature component from a signal from a balanced photodiode associated with the first sub-channel, and the signal from a balanced photodiode associate with the second sub-channel.
